(19) United States
(12) Patent Application Publication
(10) Pub. No.: US 2026/0070377 A1
(43) Pub. Date: Mar. 12, 2026

(54) TIRE TREAD HAVING A TIE BAR ASSEMBLY

(71) Applicant: Omni United (S) PTE Ltd., Singapore (SG)

(72) Inventor: Gajendra Singh Sareen, Singapore (SG)

(73) Assignee: Omni United (S) PTE Ltd., Singapore (SG)

(21) Appl. No.: 18/853,358

(22) PCT Filed: Sep. 26, 2023
(86) PCT No.: PCT/IB2023/000610

§ 371 Date: Oct. 1, 2024

Related U.S. Application Data
(60) Provisional application No. 63/538,200, filed on Sep. 13, 2023.

(51) Int. Cl. B60C 11/13; B29D 30/06

(52) U.S. Cl. CPC B60C 11/1369; B29D 30/0606; B29D 2030/0612; B60C 2200/14

(57) ABSTRACT

The present invention is an improved tire tread having a tie bar assembly having a plurality of tie bars coupling an exterior tire block to the interior tire block. The plurality of tie bars are positioned to extend in three different directions from the tire block coupling the interior tire block, which forms triangular strengthening points on the tread surfaces. With the use of the tie bar assembly having dispersed tie bars (instead of a single solid tie bar) in the present invention, tire treads can be strengthened due to increased stiffness while still preventing wear on the shoulder of the tire tread.

### RELATED APPLICATION DATA

This application claims the benefit of U.S. Provisional Application No. 63/538,200, filed Sep. 13, 2023.

### TECHNICAL FIELD

The present invention is directed to a tire tread using a plurality of dispersed tie bars.

### BACKGROUND OF THE INVENTION

Tire tread designs possess structural elements that are meant to improve the performance of the tire. There are tread blocks or block elements on a tire tread design that are constructed with either continuous ribs of repeating tread elements or circumferentially adjacent individual tread blocks. There are also grooves or sipes on a tire tread design that surround the tire tread block elements, and these grooves usually extend circumferentially and laterally on the tread around the tire tread block elements.

### DEFINITIONS

“Tread” means a molded rubber component which, when bonded to a tire casing, includes that portion of the tire that comes into contact with the road when the tire is normally inflated and under normal load.
“Axial” and “axially” refer to lines or directions that are parallel to the axis of rotation of the tire.
“Block element” and “tread block” refer to tread element protruding from the base of the tread and defined between a circumferential groove or shoulder and a pair of lateral extending grooves.
“Circumferential” means lines or directions extending along the perimeter of the surface of the annular tread, perpendicular to the axial direction.
“Groove” means an elongated void area in a tread that may extend circumferentially or laterally about the tread in a straight, curved, or zigzag manner. Grooves or sipes surround block or tread elements, and circumferentially and laterally extending grooves sometimes have common repeated portions.
“Lateral”means an axial direction.
“Radial” and “radially” refer to directions radially toward or away from the axis of rotation of the tire.
“Sipes” refers to a type of groove molded into a tire tread, and are similar to groove elements.

The number and configuration of tire block elements, and surrounding grooves and sipes, in a tread design can affect the traction and wet performance characteristics of the tire. For example, the presence of block elements increases traction of the tire tread. And, the placement and presence of grooves on the tire tread expel water from beneath the tread to prevent hydroplaning, which improves traction of the tire in snow, mud, and wet road conditions. There is a need to increase traction and water expel characteristics of tire tread designs.

Tire tread designs, and the configuration of blocks and grooves, can also impact the noise characteristics of the tire. For example, a tire tread design can generate a significant amount of noise during vehicle operation, which can be transmitted into the vehicle interior. There is a need to reduce tire noise generation characteristics on tire tread designs.

The longevity or lifespan of a tire tread is affected by the rate of wear on the tire tread from use. The rate of wear or lifespan of a tire tread are impacted by the configuration of block elements and groove configuration. In some tire tread designs, small tread blocks can reduce tire stiffness, thereby affecting performance and causing irregular wear of the tread. There is also a need to reduce wear on tire treads, as well as reducing uneven wear on tire treads.

Modifying the presence and placement of one type of structural element on a tire may negatively affect another element of the tire or other tire characteristics. And, sometimes, the placement of additional elements in the tire tread can affect the tire tread performance in a positive manner.

For example, a single “tie bar” connector has been placed between two adjacent tread blocks. A “tie bar” refers to an extra thickness of rubber that extends across a tire groove between two adjacent tread blocks. There are patents that identify several different uses of the single “tie bar” features, including U.S. Pat. Nos. 5,022,448; 5,353,854; 5,824,169; 6,631,746; 6,695,024; European Patent EP 1,685,981; Japan Patent No. 6,162,939, and Korean Patent Nos. KR100994998 and KR2010/0065958. As shown in this prior, single tie bar feature between two adjacent tread blocks has been known to stabilize the two adjacent tread blocks to a limited degree by reducing the independent movement of the two tread blocks that are separated by grooves.

While the placement of a single tire bar structure between two adjacent tread block features can improve the stiffness of the tire tread (which can improve handling and reduce irregular wear) to a limited degree, there is still a need to improve the performance of the tread designs. That is, the use of single tie bars between two adjacent tire block elements does not provide optimal performance of a tread design.

The prior art tie bar configurations are believed to not adequately reinforce the tread blocks where needed, and thereby provides only a limited increase in stiffness of the tread design. The shape of the tire blocks and the location of the tie block connector between the adjacent prior art block configurations can also negatively impact the tread's ability to expel water, which negatively increases the hydroplaning characteristics of the tire tread designs.

These patents and the prior art do not address or counter the above problems encountered by the prior art; and, as such, there is a need for an invention that more efficiently and effectively improves the characteristics of the tire tread design. A need therefore exists for an improved tire tread design which overcomes these and other drawbacks of the prior art. There is a present need for a tire tread design that solves the problems of weakened strength, abnormal wear and grip force of the tire. Additionally, there is a need for an improved tire tread design that overcomes these and other drawbacks of the prior art.

### SUMMARY OF THE INVENTION

The present invention is an improved tire tread having a tie bar assembly that overcomes the drawbacks of the prior art tire with a tread having a plurality of tie bars between a pair of tire blocks. The size and shape of the tire blocks and the location, presence, and number of tie bar connectors between the adjacent tire blocks has been shown (compared to prior art tread designs) to increase the stiffness and traction of the tire tread, increase the tread's ability to expel water, increase tread durability, and reduce wear (and uneven wear) of the tire tread.

The tie bar assembly comprises a plurality of tie bars 123A, 123B and 123C coupling the second exterior tire block 114 to the interior concave polygon tire block 122. The placement, configuration, and number of tire bars is significant to improve the tread characteristics, with the tire strength and stiffness being improved by the placement of a plurality of tie bars 123A, 123B and 123C extending in three different directions from the second exterior tire block 114 for coupling to the interior concave polygon tire block 122. The placement of the tie bars 123A, 123B and 123C in this configuration forms triangular strengthening points on the tread surfaces.

Certain block designs, such as wing blocks and shoulder blocks, are too unstable to use on their own, and these wing and should blocks can also lead to tread wear on the should of the tread. With the use of the tie bar assembly in the present invention, however, tire treads can now incorporate block designs, such as wing blocks and shoulder blocks, because of the increase stiffness and strength provided by the tie bar assembly located between tire block components. Further, dispersing the tie bars into a plurality configuration between the pair of tire blocks can still prevent the shoulder of the tread from becoming too rigid. The present invention provides an optimal combination of increased tire tread stability and decreased shoulder area rigidity.

### BRIEF DESCRIPTION OF THE DRAWINGS

The invention will be described by way of example and with reference to the accompanying drawings in which the accompanying drawings illustrate embodiments of the invention, as follows.

FIG. 1 is a perspective view of the tire tread having a tie bar assembly;

FIG. 2 is a front view of the tire tread having a tie bar assembly;

FIG. 3 is a segmented perspective view of a portion of the tire tread having a tie bar assembly shown in FIG. 1;

FIG. 4A is a segmented view of a portion of the tire tread having a tie bar assembly;

FIG. 4B is a segmented view of a tread block having a tie bar assembly;

FIG. 4C is a cross sectional view A-A of the tread block having a tie bar assembly shown in FIG. 4B;

FIG. 5 is a segmented front view of a portion of the tire tread having a tie bar assembly shown in FIG. 1; and,

FIGS. 6 and 7 are segmented perspective views of a portion of the tire tread having a tie bar assembly shown in FIG. 1.

### DETAILED DESCRIPTION

The present invention relates to an improved tire tread using a tie bar assembly, as well as to a method and a mold to make such a tire tread. The tire tread using a tie bar assembly of the present invention relates to a tire for any type of vehicle. And, a tire using the improved tire tread having the tie bar assembly has improved strength characteristics, as well as improved elimination of water and wear characteristics.

The present invention relates to a tire for an automobile, and more particularly, to provide a tire obtained by improving a tie bar assembly formed in a groove to improve strength of the tire tread, reduce abnormal wear and a grip force of a tire. The present invention relates to an improved tire tread design using a plurality of tie bars between a pair of tire blocks.

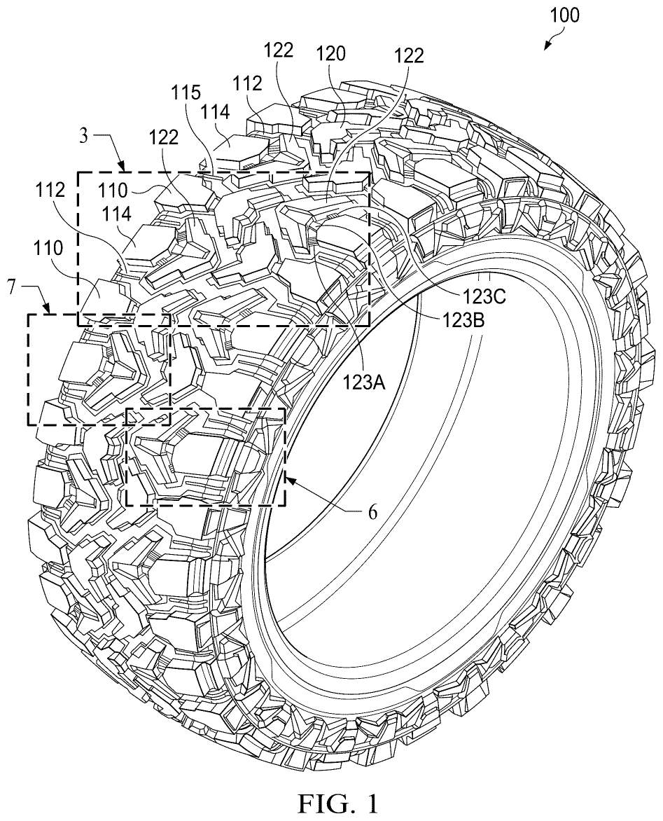

As shown in FIG. 1, the present invention is a tire with a tire tread 100 having tread blocks, tire grooves and a tie bar assembly shown therein. Tire tread 100 has four reciprocal and repeating columns of tread features. The first exterior tire block 110 is associated with, and may be coupled to, interior reciprocal tire block 120. Second exterior tire block 114 is associated with an interior concave polygon tire block 122.

The interior concave polygon tire block 122 can be configured in numerous other shapes, such as polygons, quadrilaterals, concave quadrilaterals, squares, rectangles, or other shapes. Likewise, the interior reciprocal tire block 120 can be configured in numerous other shapes, such as quadrilaterals, concave quadrilaterals, convex quadrilaterals, squares, rectangles, or other shapes. The exterior tire blocks 114 and 110, likewise, can be designed into different shapes from those shown, such as polygons, quadrilaterals, concave quadrilaterals, squares, rectangles, or other shapes.

On one side of the second exterior tire block 114, groove 112 separates the first exterior tire block 110 from second exterior tire block 114. And, on the other side of the second exterior tire block 114, groove 115 separates the first exterior tire block 110 from second exterior tire block 114.

The tie bar assembly comprises a plurality of tie bars 123A, 123B and 123C coupling the second exterior tire block 114 to the interior concave polygon tire block 122. The placement, configuration, and number of tire bars is significant to improve the tread characteristics, with the tire strength and stiffness being improved by the placement of a plurality of tie bars 123A, 123B and 123C extending in three different directions from the second exterior tire block 114 for coupling to the interior concave polygon tire block 122.

The placement of the tie bars 123A, 123B and 123C in this configuration forms triangular strengthening points on the tread surfaces. The first triangular strengthening feature is defined between tie bars 123A and 123B and their coupling with the second exterior tire block 114 to the interior concave polygon tire block 122. The second triangular strengthening feature is defined between tie bars 123C and 123B and their coupling with the second exterior tire block 114 to the interior concave polygon tire block 122. And, a third triangular strengthening feature is defined between tie bars 123A and 123C and their coupling with the second exterior tire block 114 to the interior concave polygon tire block 122.

FIG. 1 shows a particular embodiment, but there are other placements of the plurality of tie bars between two tire blocks that may, in like manner, strengthen and stiffen a tire tread according to the teachings in the present invention. The use of tie bars in this manner increases the stiffness of the tire tread, even when unconventional or smaller tire block configurations are incorporated into the tire tread design. Further, the tie bar assembly in the present invention demonstrated in FIG. 1 also improves elimination of water and wear characteristics of the shoulder of the tire tread.

With the use of the tie bar assembly in the present invention, tire treads can now incorporate block designs, such as wing blocks and shoulder blocks, because of the increase stiffness and strength provided by the tie bar assembly located between tire block components. Further, dispersing the tie bars in a plurality configuration between the pair of tire blocks can still prevent the shoulder of the tread from becoming too rigid. The present invention provides an optimal combination of increased tire tread stability and decreased shoulder area rigidity.

The tie bar assembly in the present invention as shown in FIG. 1 provides a stiffening effect to suppress excessive rotational movement of the tire block and reinforce the rigidity of the blocks connected to the tie bar assembly and neighboring tire blocks. By improving the stiffness of the tread design, one also reduces abnormal wear phenomenon by providing a more uniform stiffness around the entire tire tread.

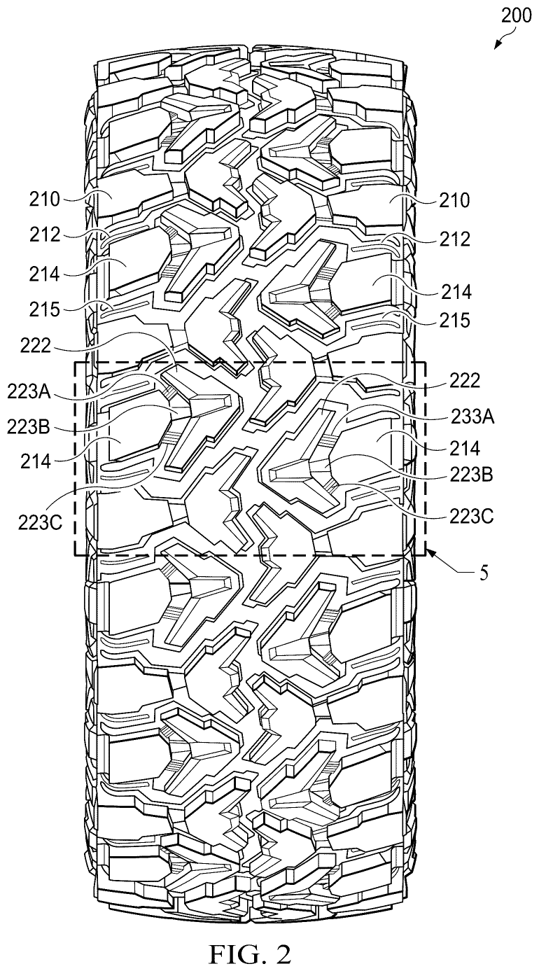

As shown in FIG. 2, the present invention is a tire with a tire tread 200 having tread blocks, tire grooves and a tie bar assembly shown therein. Tire tread 200 has four reciprocal and repeating columns of tread features. The first exterior tire block 210 is associated with, and may be coupled to, interior reciprocal tire block 220. Second exterior tire block 214 is associated with an interior concave polygon tire block 222.

The interior concave polygon tire block 222 can be configured in numerous other shapes, such as polygons, quadrilaterals, concave quadrilaterals, squares, rectangles, or other shapes. Likewise, the interior reciprocal tire block 220 can be configured in numerous other shapes, such as quadrilaterals, concave quadrilaterals, convex quadrilaterals, squares, rectangles, or other shapes. The exterior tire blocks 214 and 210, likewise, can be designed into different shapes from those shown, such as polygons, quadrilaterals, concave quadrilaterals, squares, rectangles, or other shapes.

On one side of the second exterior tire block 214, groove 212 separates the first exterior tire block 210 from second exterior tire block 214. And, on the other side of the second exterior tire block 214, groove 215 separates the first exterior tire block 210 from second exterior tire block 214.

The tie bar assembly comprises a plurality of tie bars 223A, 223B and 223C coupling the second exterior tire block 214 to the interior concave polygon tire block 222. The placement, configuration, and number of tire bars is significant to improve the tread characteristics, with the tire strength and stiffness being improved by the placement of a plurality of tie bars 223A, 223B and 223C extending in three different directions from the second exterior tire block 214 for coupling to the interior concave polygon tire block 222.

The placement of the tie bars 223A, 223B and 223C in this configuration forms triangular strengthening points on the tread surfaces. The first triangular strengthening feature is defined between tie bars 223A and 223B and their coupling with the second exterior tire block 214 to the interior concave polygon tire block 222. The second triangular strengthening feature is defined between tie bars 223C and 223B and their coupling with the second exterior tire block 214 to the interior concave polygon tire block 222. And, a third triangular strengthening feature is defined between tie bars 223A and 223C and their coupling with the second exterior tire block 114 to the interior concave polygon tire block 222.

FIG. 2 shows a particular embodiment, but there are other placements of the plurality of tie bars between two tire blocks that may, in like manner, strengthen and stiffen a tire tread according to the teachings in the present invention. The use of tie bars in this manner increases the stiffness of the tire tread, even when unconventional or smaller tire block configurations are incorporated into the tire tread design. Further, the tie bar assembly in the present invention demonstrated in FIG. 2 also improves elimination of water and wear characteristics of the shoulder of the tire tread.

With the use of the tie bar assembly in the present invention, tire treads can now incorporate block designs, such as wing blocks and shoulder blocks, because of the increase stiffness and strength provided by the tie bar assembly located between tire block components. Further, dispersing the tie bars in a plurality configuration between the pair of tire blocks can still prevent the shoulder of the tread from becoming too rigid. The present invention provides an optimal combination of increased tire tread stability and decreased shoulder area rigidity.

The tie bar assembly in the present invention as shown in FIG. 2 provides a stiffening effect to suppress excessive rotational movement of the tire block and reinforce the rigidity of the blocks connected to the tie bar assembly and neighboring tire blocks. By improving the stiffness of the tread design, one also reduces abnormal wear phenomenon by providing a more uniform stiffness around the entire tire tread.

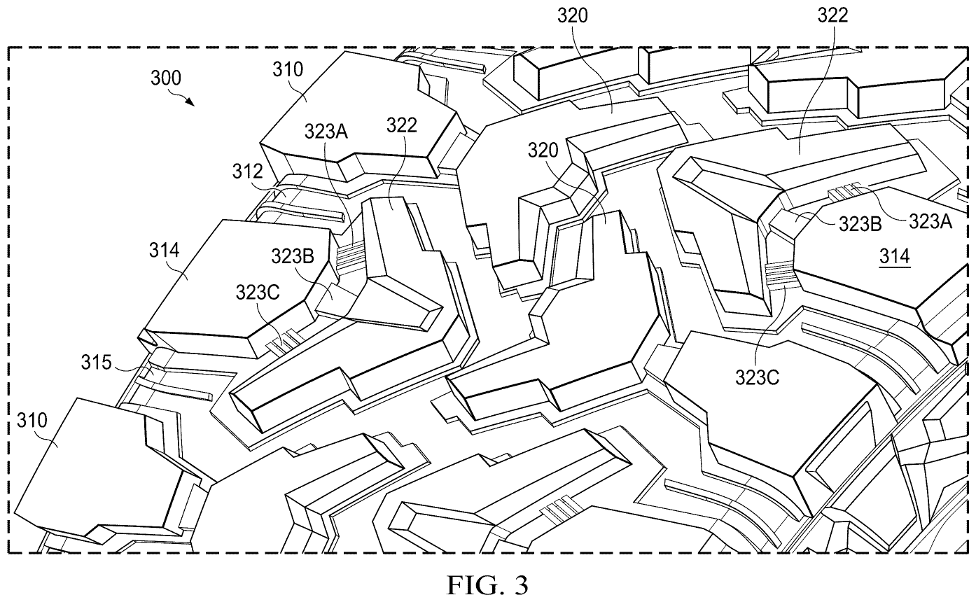

As shown in FIG. 3, the present invention is a tire with a tire tread 300 having tread blocks, tire grooves and a tie bar assembly shown therein. Tire tread 300 has four reciprocal and repeating columns of tread features. The first exterior tire block 310 is associated with, and may be coupled to, interior reciprocal tire block 320. Second exterior tire block 314 is associated with an interior concave polygon tire block 322.

The interior concave polygon tire block 322 can be configured in numerous other shapes, such as polygons, quadrilaterals, concave quadrilaterals, squares, rectangles, or other shapes. Likewise, the interior reciprocal tire block 320 can be configured in numerous other shapes, such as quadrilaterals, concave quadrilaterals, convex quadrilaterals, squares, rectangles, or other shapes. The exterior tire blocks 314 and 310, likewise, can be designed into different shapes from those shown, such as polygons, quadrilaterals, concave quadrilaterals, squares, rectangles, or other shapes.

On one side of the second exterior tire block 314, groove 312 separates the first exterior tire block 310 from second exterior tire block 314. And, on the other side of the second exterior tire block 314, groove 315 separates the first exterior tire block 310 from second exterior tire block 314.

The tie bar assembly comprises a plurality of tie bars 323A, 323B and 323C coupling the second exterior tire block 314 to the interior concave polygon tire block 322. The placement, configuration, and number of tire bars is significant to improve the tread characteristics, with the tire strength and stiffness being improved by the placement of a plurality of tie bars 323A, 323B and 323C extending in three different directions from the second exterior tire block 314 for coupling to the interior concave polygon tire block 322.

The placement of the tie bars 323A, 323B and 323C in this configuration forms triangular strengthening points on the tread surfaces. The first triangular strengthening feature is defined between tie bars 323A and 323B and their coupling with the second exterior tire block 314 to the interior concave polygon tire block 322. The second triangular strengthening feature is defined between tie bars 323C and 323B and their coupling with the second exterior tire block 314 to the interior concave polygon tire block 322. And, a third triangular strengthening feature is defined between tie bars 323A and 323C and their coupling with the second exterior tire block 314 to the interior concave polygon tire block 322.

FIG. 3 shows a particular embodiment, but there are other placements of the plurality of tie bars between two tire blocks that may, in like manner, strengthen and stiffen a tire tread according to the teachings in the present invention. The use of tie bars in this manner increases the stiffness of the tire tread, even when unconventional or smaller tire block configurations are incorporated into the tire tread design. Further, the tie bar assembly in the present invention demonstrated in FIG. 3 also improves elimination of water and wear characteristics of the shoulder of the tire tread.

With the use of the tie bar assembly in the present invention, tire treads can now incorporate block designs, such as wing blocks and shoulder blocks, because of the increase stiffness and strength provided by the tie bar assembly located between tire block components. Further, dispersing the tie bars in a plurality configuration between the pair of tire blocks can still prevent the shoulder of the tread from becoming too rigid. The present invention provides an optimal combination of increased tire tread stability and decreased shoulder area rigidity.

The tie bar assembly in the present invention as shown in FIG. 3 provides a stiffening effect to suppress excessive rotational movement of the tire block and reinforce the rigidity of the blocks connected to the tie bar assembly and neighboring tire blocks. By improving the stiffness of the tread design, one also reduces abnormal wear phenomenon by providing a more uniform stiffness around the entire tire tread.

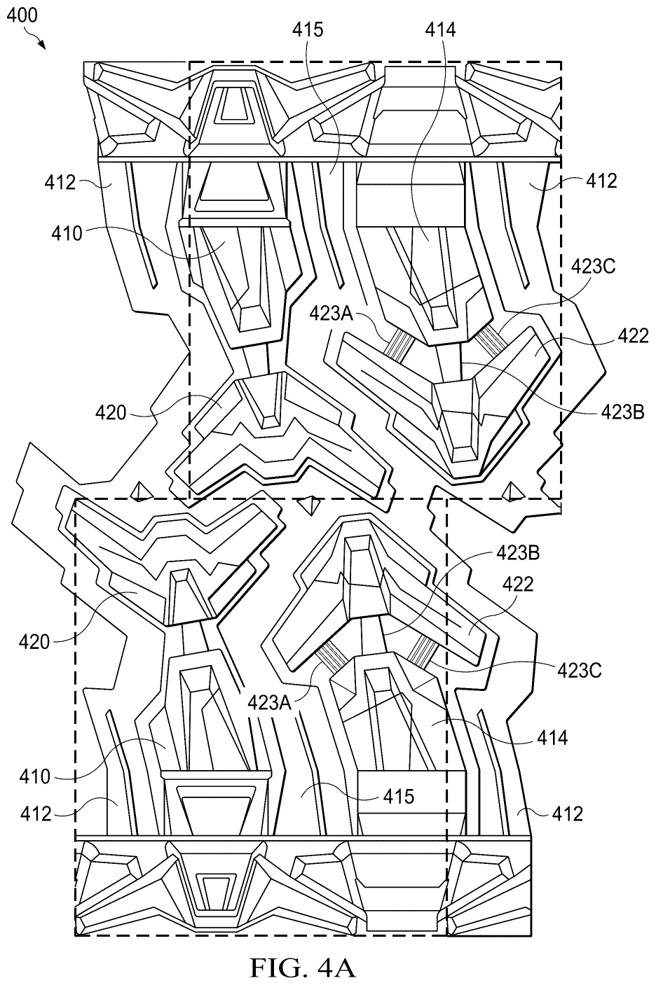

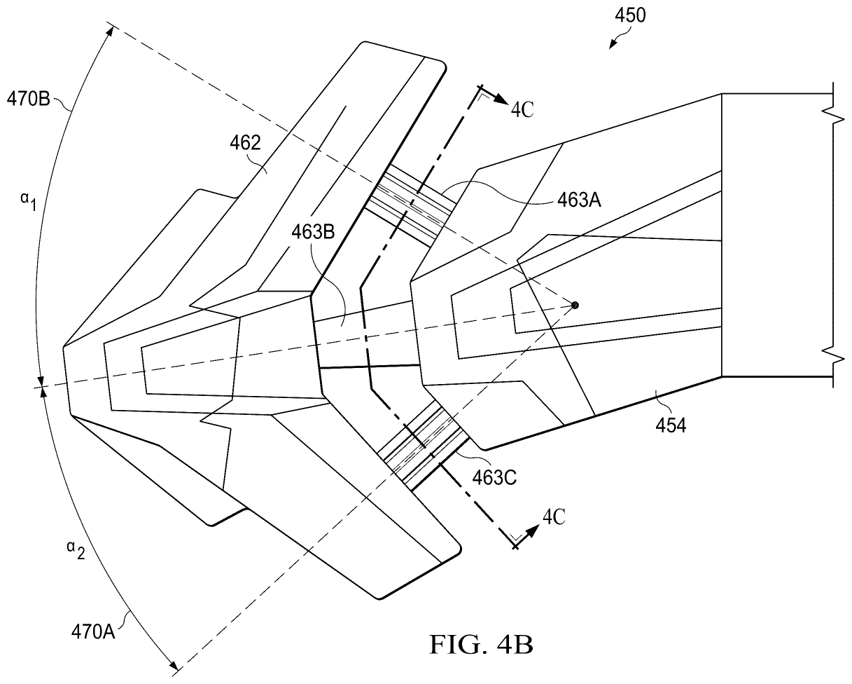

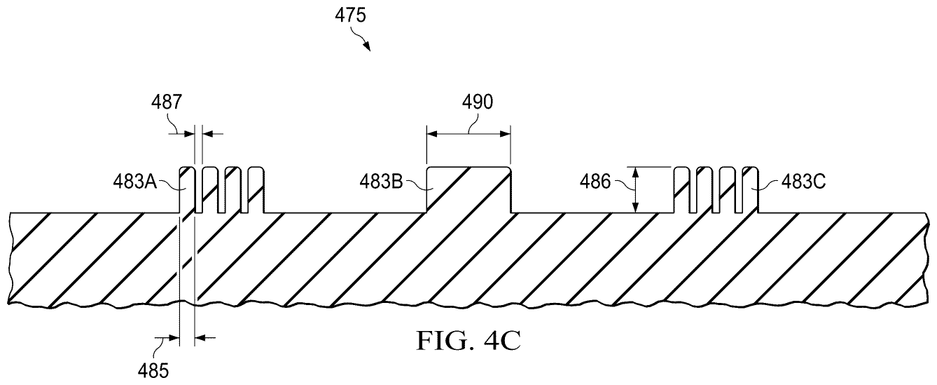

As shown in FIG. 4A, the present invention is a tire with a tire tread 400 having tread blocks, tire grooves and a tie bar assembly shown therein. Tire tread 400 has four reciprocal and repeating columns of tread features. The first exterior tire block 410 is associated with, and may be coupled to, interior reciprocal tire block 420. Second exterior tire block 414 is associated with an interior concave polygon tire block 422.

The interior concave polygon tire block 422 can be configured in numerous other shapes, such as polygons, quadrilaterals, concave quadrilaterals, squares, rectangles, or other shapes. Likewise, the interior reciprocal tire block 420 can be configured in numerous other shapes, such as quadrilaterals, concave quadrilaterals, convex quadrilaterals, squares, rectangles, or other shapes. The exterior tire blocks 414 and 410, likewise, can be designed into different shapes from those shown, such as polygons, quadrilaterals, concave quadrilaterals, squares, rectangles, or other shapes.

On one side of the second exterior tire block 414, groove 412 separates the first exterior tire block 410 (this block not shown in FIG. 4A) from the second exterior tire block 414. And, on the other side of the second exterior tire block 414, groove 415 separates the first exterior tire block 410 from second exterior tire block 414.

The tie bar assembly comprises a plurality of tie bars 423A, 423B and 423C coupling the second exterior tire block 414 to the interior concave polygon tire block 422. The placement, configuration, and number of tire bars is significant to improve the tread characteristics, with the tire strength and stiffness being improved by the placement of a plurality of tie bars 423A, 423B and 423C extending in three different directions from the second exterior tire block 414 for coupling to the interior concave polygon tire block 422.

The placement of the tie bars 423A, 423B and 423C in this configuration forms triangular strengthening points on the tread surfaces. The first triangular strengthening feature is defined between tie bars 423A and 423B and their coupling with the second exterior tire block 414 to the interior concave polygon tire block 422. The second triangular strengthening feature is defined between tie bars 423C and 423B and their coupling with the second exterior tire block 414 to the interior concave polygon tire block 422. And, a third triangular strengthening feature is defined between tie bars 423A and 423C and their coupling with the second exterior tire block 414 to the interior concave polygon tire block 422.

As shown in FIG. 4B, a portion of the tire tread 450 shows a single pair of tire blocks 454, 462 coupled with a tie bar assembly 463A, 463B, 463C, which shows more details of the present invention. In FIG. 4B, the second exterior tire block 454 is associated with an interior concave polygon tire block 462. The other tire blocks and groove patterns are not shown in this particular figure. The tie bar assembly comprises a plurality of tie bars 463A, 463B and 463C coupling the second exterior tire block 454 to the interior concave polygon tire block 462.

The placement, configuration, and number of tire bars is significant to improve the tread characteristics, with the tire strength and stiffness being improved by the placement of a plurality of tie bars 463A, 463B and 463C extending in three different directions from the second exterior tire block 454 for coupling to the interior concave polygon tire block 462. The interior concave polygon tire block 462 can be configured in numerous other shapes, such as polygons, quadrilaterals, concave quadrilaterals, squares, rectangles, or other shapes. Likewise, the exterior tire blocks 454 can be designed into different shapes from those shown, such as polygons, quadrilaterals, concave quadrilaterals, squares, rectangles, or other shapes.

As shown more specifically in FIG. 4B, the placement of the tie bars 463A, 463B and 463C in this configuration forms triangular strengthening points on the tread surfaces. The first triangular strengthening feature is defined between tie bars 463A and 463B and their coupling with the second exterior tire block 454 to the interior concave polygon tire block 462. The placement of the tie bars 483A, 483B, 483C is shown in a balanced spaced apart configuration, but the tie bars 483A, 483B, 483C can be placed in a variable spaced apart configuration while still capturing the benefits of the present invention depending on the desired tire characteristics.

The depth (length of tie bar between blocks) of the respective tie bars 483A, 483B, and 483C is shown preferably at 6 mm, but can range between 4 mm to 8 mm in the preferred embodiment. Also, depending on the size of the tire blocks and tread design, the depth of the tie bars 483A, 483B, 483C can alternatively range between 30% to 75% of preferred depth ranges while still capturing the benefits of the present invention, and balance the desired characteristics of the tire tread.

The width (cross section 90 degrees offset from length of tie bar between blocks) of the respective tie bars 483A, 483B, and 483C is shown preferably at 1 mm, but can range between 0.5 mm to 1.5 mm in the preferred embodiment. Also, depending on the size of the tire blocks and tread design, the width of the tie bars 483A, 483B, 483C can alternatively range between 20% to 90% of preferred width ranges while still capturing the benefits of the present invention, and balance the desired characteristics of the tire tread.

There is an acute angle a1 470B is shown preferably at approximately 40 degrees but can range preferably between 30 degrees to 50 degrees in the preferred embodiment. Alternatively, the acute angle α₁ 470B can range between 20 degrees to 60 degrees to capture the benefits of the present invention and balance the increased stiffness in the tread and reduced wear on the shoulder (avoid tire shoulder being too rigid).

The second triangular strengthening feature is defined between tie bars 463C and 463B and their coupling with the second exterior tire block 454 to the interior concave polygon tire block 462. There is an acute angle α₂ 470A is shown preferably at approximately 40 degrees but can range preferably between 30 degrees to 50 degrees in the preferred embodiment. Alternatively, the acute angle α₂ 470 A can range between 20 degrees to 60 degrees to capture the benefits of the present invention and balance the increased stiffness in the tread and reduced wear on the shoulder (avoid tire shoulder being too rigid).

And, a third triangular strengthening feature is defined between tie bars 463A and 463C and their coupling with the second exterior tire block 454 to the interior concave polygon tire block 462. There is a combined angle α₁ 470B and α₂ 470A is shown preferably at approximately 80 degrees but can range preferably between 70 degrees to 90 degrees in the preferred embodiment. Alternatively, the combined angle at α₁ 470B and α₂ 470A can range between 50 degrees to 110 degrees to capture the benefits of the present invention and balance the increased stiffness in the tread and reduced wear on the shoulder (avoid tire shoulder being too rigid).

As shown in FIG. 4B, the angle α₁ 470B and α₂ 470A are approximately equal valued, which shows placement of the tie bars 483A, 483B, 483C to be in a uniform spaced configuration. The angle α₁ 470B and α₂ 470A, however, can vary from each other in a spaced apart configuration while still capturing the benefits of the present invention depending on the desired tire characteristics.

In FIG. 4C, the tire tread 475 shows a cross section A-A marked line from FIG. 4B base of the tire tread and the tie bars 483A, 483B, 483C. The height of the respective tie bars 483A, 483B, and 483C is shown preferably at 1 mm, but can range between 0.5 mm to 2 mm in the preferred embodiment. Also, depending on the size of the tire blocks and tread design, the height of the tie bars 483A, 483B, 483C can alternatively range between 35% to 65% of preferred height ranges while still capturing the benefits of the present invention, and balance the desired characteristics of the tire tread.

Moreover, the tie bars 483A, 483B, 483C are shown with a uniform height across the individual tie bars 483A, 483B, 483C, but the height of the tie bar can alternatively vary from the tie bars 483A, 483B, 483C (e.g. one shorter tie bar, one taller, etc.) or the height of the individual tie bars 483A, 483B, 483C can vary on by slanting the individual tie bar height (e.g. from front to back, side to side, etc.) while still capturing the benefits of the present invention.

The tie bars 483A, 483C are shown in a groove configuration and the tie bar 483B is shown in a solid configuration. While the preferred embodiment shows this combination of solid tie bar 483B surrounded by grooved configuration tie bars 483A, 483C, the grooved and solid configuration of tie bars can be adjusted such that all the tie bars are grooved, all the tie bars are solid, or any combination therein while still capturing the benefits of the present invention depending on the desired tire characteristics.

In FIG. 4C, tie bar 483A is shown by the configuration defined by ridges 485 and grooves 487, each ridge 485 having a width of 0.25 mm and a depth of approximately 1 mm. The width of the tie bar ridge 485 can range between 0.15 mm to 0.35 mm in the preferred embodiment. Also, depending on the size of the tire blocks and tread design, the width of the tie bar ridge 485 can alternatively range between 25% to 65% of preferred width ranges while still capturing the benefits of the present invention, and balance the desired characteristics of the tire tread.

And, each groove 487 in tie bar 483A has a width of 0.125 mm and a depth of approximately 1 mm. And, the width of the tie bar groove 487 can range between 0.05 mm to 0.20 mm in the preferred embodiment. Also, depending on the size of the tire blocks and tread design, the width of the tie bar groove 487 can alternatively range between 55% to 85% of preferred width ranges while still capturing the benefits of the present invention, and balance the desired characteristics of the tire tread. The height and widths of the tie bar ridges 485 and grooves 487 can be uniform, but these height and widths can be varied in an alternative embodiment in an individual tie bar 483A, 483B or 483C or varied between tie bars 483A, 483B and 483C in the tie bar assembly.

FIGS. 4A, 4B and 4C show a particular embodiment, but there are other placements of the plurality of tie bars between two tire blocks that may, in like manner, strengthen and stiffen a tire tread according to the teachings in the present invention. The use of tie bars in this manner increases the stiffness of the tire tread, even when unconventional or smaller tire block configurations are incorporated into the tire tread design. Further, the tie bar assembly in the present invention demonstrated in FIGS. 4A, 4B and 4C also improves elimination of water and wear characteristics of the shoulder of the tire tread.

With the use of the tie bar assembly in the present invention, tire treads can now incorporate block designs, such as wing blocks and shoulder blocks, because of the increase stiffness and strength provided by the tie bar assembly located between tire block components. Further, dispersing the tie bars in a plurality configuration between the pair of tire blocks can still prevent the shoulder of the tread from becoming too rigid. The present invention provides an optimal combination of increased tire tread stability and decreased shoulder area rigidity.

The tie bar assembly in the present invention as shown in FIGS. 4A, 4B and 4C provides a stiffening effect to suppress excessive rotational movement of the tire block and reinforce the rigidity of the blocks connected to the tie bar assembly and neighboring tire blocks. By improving the stiffness of the tread design, one also reduces abnormal wear phenomenon by providing a more uniform stiffness around the entire tire tread.

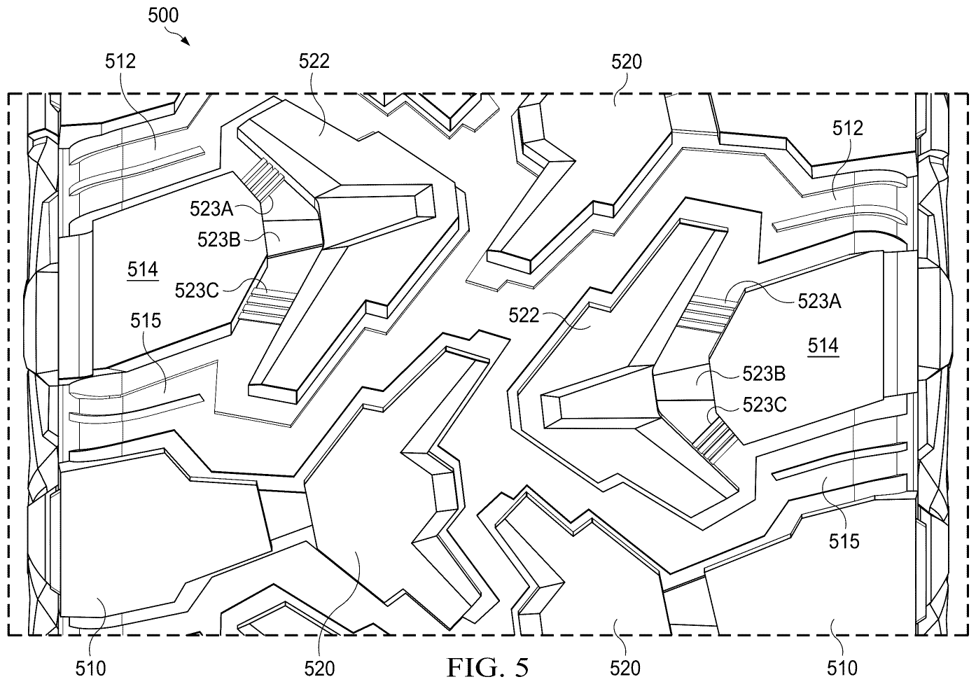

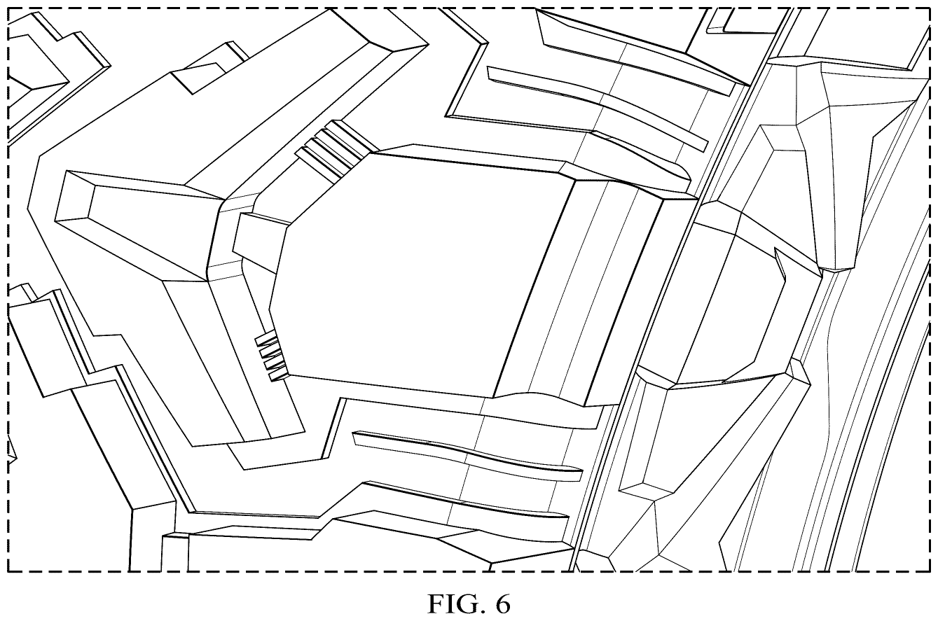

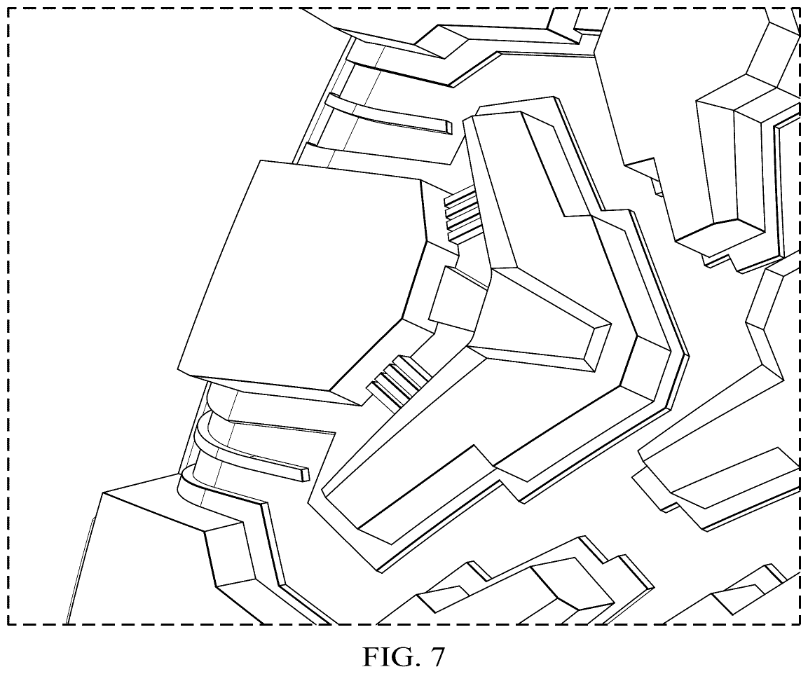

As shown in FIG. 5, the present invention is a tire with a tire tread 500 having tread blocks, tire grooves and a tie bar assembly shown therein. Tire tread 500 has four reciprocal and repeating columns of tread features. The first exterior tire block 510 is associated with, and may be coupled to, interior reciprocal tire block 520. Second exterior tire block 514 is associated with an interior concave polygon tire block 522.

The interior concave polygon tire block 522 can be configured in numerous other shapes, such as polygons, quadrilaterals, concave quadrilaterals, squares, rectangles, or other shapes. Likewise, the interior reciprocal tire block 520 can be configured in numerous other shapes, such as quadrilaterals, concave quadrilaterals, convex quadrilaterals, squares, rectangles, or other shapes. The exterior tire blocks 514 and 510, likewise, can be designed into different shapes from those shown, such as polygons, quadrilaterals, concave quadrilaterals, squares, rectangles, or other shapes.

On one side of the second exterior tire block 514, groove 512 separates the first exterior tire block 510 from second exterior tire block 514. And, on the other side of the second exterior tire block 514, groove 515 separates the first exterior tire block 510 from second exterior tire block 514.

The tie bar assembly comprises a plurality of tie bars 523A, 523B and 523C coupling the second exterior tire block 514 to the interior concave polygon tire block 522. The placement, configuration, and number of tire bars is significant to improve the tread characteristics, with the tire strength and stiffness being improved by the placement of a plurality of tie bars 523A, 523B and 523C extending in three different directions from the second exterior tire block 514 for coupling to the interior concave polygon tire block 522.

The placement of the tie bars 523A, 523B and 523C in this configuration forms triangular strengthening points on the tread surfaces. The first triangular strengthening feature is defined between tie bars 523A and 523B and their coupling with the second exterior tire block 514 to the interior concave polygon tire block 522. The second triangular strengthening feature is defined between tie bars 523C and 523B and their coupling with the second exterior tire block 514 to the interior concave polygon tire block 522. And, a third triangular strengthening feature is defined between tie bars 523A and 523C and their coupling with the second exterior tire block 514 to the interior concave polygon tire block 522.

FIG. 5 shows a particular embodiment, but there are other placements of the plurality of tie bars between two tire blocks that may, in like manner, strengthen and stiffen a tire tread according to the teachings in the present invention. The use of tie bars in this manner increases the stiffness of the tire tread, even when unconventional or smaller tire block configurations are incorporated into the tire tread design. Further, the tie bar assembly in the present invention demonstrated in FIG. 5 also improves elimination of water and wear characteristics of the shoulder of the tire tread.

With the use of the tie bar assembly in the present invention, tire treads can now incorporate block designs, such as wing blocks and shoulder blocks, because of the increase stiffness and strength provided by the tie bar assembly located between tire block components. Further, dispersing the tie bars in a plurality configuration between the pair of tire blocks can still prevent the shoulder of the tread from becoming too rigid. The present invention provides an optimal combination of increased tire tread stability and decreased shoulder area rigidity.

The tie bar assembly in the present invention as shown in FIG. 5 provides a stiffening effect to suppress excessive rotational movement of the tire block and reinforce the rigidity of the blocks connected to the tie bar assembly and neighboring tire blocks. By improving the stiffness of the tread design, one also reduces abnormal wear phenomenon by providing a more uniform stiffness around the entire tire tread.

In another embodiment, the process for making the tire according to the present invention is formed in a mold having a plurality of molding members for forming the tread with individual molding elements used to form the tire tread 100 with four reciprocal and repeating columns of tread features. The mold has molding members that form the first exterior tire block 110 associated with, and may be coupled to, interior reciprocal tire block 120, as well as the second exterior tire block 114 associated with an interior concave polygon tire block 122.

In the process for making the tire 100, the interior concave polygon tire block 122 can be configured in numerous other shapes, such as polygons, quadrilaterals, concave quadrilaterals, squares, rectangles, or other shapes. Likewise, the interior reciprocal tire block 120 can be configured in numerous other shapes, such as quadrilaterals, concave quadrilaterals, convex quadrilaterals, squares, rectangles, or other shapes. The exterior tire blocks 114 and 110, likewise, can be designed into different shapes from those shown, such as polygons, quadrilaterals, concave quadrilaterals, squares, rectangles, or other shapes.

In the process for making the tire 100, the mold forms on one side of the second exterior tire block 114 a groove 112 that separates the first exterior tire block 110 from second exterior tire block 114; and, on the other side of the second exterior tire block 114, the mold forms groove 115 that separates the first exterior tire block 110 from second exterior tire block 114.

The mold in the process for making the tire 100 forms a tie bar assembly that comprises a plurality of tie bars 123A, 123B and 123C coupling the second exterior tire block 114 to the interior concave polygon tire block 122. The placement, configuration, and number of tire bars is significant to improve the tread characteristics, with the tire strength and stiffness being improved by the placement of a plurality of tie bars 123A, 123B and 123C extending in three different directions from the second exterior tire block 114 for coupling to the interior concave polygon tire block 122.

The mold will dictate the placement of the tie bars 123A, 123B and 123C in this configuration to form triangular strengthening points on the tread surfaces. The first triangular strengthening feature is defined between tie bars 123A and 123B and their coupling with the second exterior tire block 114 to the interior concave polygon tire block 122. The second triangular strengthening feature is defined between tie bars 123C and 123B and their coupling with the second exterior tire block 114 to the interior concave polygon tire block 122. And, a third triangular strengthening feature is defined between tie bars 123A and 123C and their coupling with the second exterior tire block 114 to the interior concave polygon tire block 122.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

Having described the invention, we claim:

1. A tire, comprising:
a tire tread having a first exterior tire block associated with an interior reciprocal tire block and a second exterior tire block associated with an interior tire block;
a first groove on the tire tread separating the first exterior tire block from second exterior tire block and a second groove separating the first exterior tire block from second exterior tire block;
a tie bar assembly having a plurality of tie bars coupling the second exterior tire block to the interior tire block, the tie bars extending in three different directions from the second exterior tire block for coupling to the interior tire block;
said tie bars having a groove configuration and the tie bar having a solid body configuration, with the solid body tie bar surrounded by grooved configuration tie bars said tie bar groove configurations defined by ridges and grooves with each ridge having a width of 0.25 mm and a depth of approximately 1 mm and the width of the tie bar ridge can range between 0.15 mm to 0.35 mm, and the groove in grooved tie bar has a width of 0.125 mm and a depth of approximately 1 mm.

2. The tire as set forth in claim 1 above wherein the depth (length of tie bar between blocks) of the tie bars is between 4 mm to 8 mm.

3. The tire as set forth in claim 1 above wherein the width (cross section 90 degrees offset from length of tie bar between blocks) of the tie bars is between 0.5 mm to 1.5 mm.

4. The tire as set forth in claim 1 above wherein the height of the tie bars is between 0.5 mm to 2 mm.

5. The tire as set forth in claim 1 above wherein a plurality of tie bars and the interior tire block define a first triangular strengthening feature having an acute angle α1 that is between 30 degrees to 50 degrees.

6. The tire as set forth in claim 1 above wherein a plurality of tie bars and the interior tire block define a second triangular strengthening feature having an acute angle α2 that is between 30 degrees to 50 degrees.

7. The tire as set forth in claim 1 above wherein the interior tire block can be configured as a polygon, quadrilateral, concave quadrilateral, square, or rectangle.

8. The tire as set forth in claim 1 above wherein the interior reciprocal tire block can be configured as a quadrilateral, concave quadrilateral, convex quadrilateral, square, or rectangles.

9. The tire as set forth in claim 1 above wherein the exterior tire blocks can be configured as a polygon, quadrilateral, concave quadrilateral, square, or rectangle.

10. A tire, comprising:
a tire tread having a first exterior tire block associated with an interior reciprocal tire block and a second exterior tire block associated with an interior tire block;
a first groove on the tire tread separating the first exterior tire block from second exterior tire block and a second groove separating the first exterior tire block from second exterior tire block;
a tie bar assembly having a plurality of tie bars coupling the second exterior tire block to the interior tire block, the tie bars extending from the second exterior tire block for coupling to the interior tire block.

11. The tire as set forth in claim 10 above wherein the depth (length of tie bar between blocks) of the tie bars is between 4 mm to 8 mm.

12. The tire as set forth in claim 10 above wherein the width (cross section 90 degrees offset from length of tie bar between blocks) of the tie bars is between 0.5 mm to 1.5 mm.

13. The tire as set forth in claim 10 above wherein the height of the tie bars is between 0.5 mm to 2 mm.

14. The tire as set forth in claim 10 above wherein a plurality of tie bars and the interior tire block define a first triangular strengthening feature having an acute angle α1 that is between 30 degrees to 50 degrees.

15. The tire as set forth in claim 10 above wherein a plurality of tie bars and the interior tire block define a second triangular strengthening feature having an acute angle α2 that is between 30 degrees to 50 degrees.

16. The tire as set forth in claim 10 above wherein one or more tie bars having a groove configuration.

17. The tire as set forth in claim 10 above wherein one or more tie bars have a solid body configuration.

18. A method of making a tire, comprising:
forming a tire tread with a first mold, said tire having a first exterior tire block associated with an interior reciprocal tire block and a second exterior tire block associated with an interior tire block;
placing a first groove on the tire tread with said first mold, said first groove separating the first exterior tire block from second exterior tire block;
placing a second groove on the tire tread with said first mold, said second groove separating the first exterior tire block from second exterior tire block;
placing a tie bar assembly on the tire tread with the first mold, said tie bar assembly having a plurality of tie bars coupling the second exterior tire block to the interior tire block, the tie bars extending in three different directions from the second exterior tire block for coupling to the interior tire block.

19. The method of making the tire as set forth in claim 18 above wherein the depth (length of tie bar between blocks) of the tie bars is between 4 mm to 8 mm.

20. The method of making the tire as set forth in claim 18 wherein the width (cross section 90 degrees offset from length of tie bar between blocks) of the tie bars is between 0.5 mm to 1.5 mm.

21. The method of making the tire as set forth in claim 18 wherein the height of the tie bars is between 0.5 mm to 2 mm.

22. The method of making the tire as set forth in claim 18 wherein a plurality of tie bars and the interior tire block define a first triangular strengthening feature having an acute angle α1 that is between 30 degrees to 50 degrees.

23. The method of making the tire as set forth in claim 18 wherein a plurality of tie bars and the interior tire block define a second triangular strengthening feature having an acute angle α2 that is between 30 degrees to 50 degrees.

24. The method of making the tire as set forth in claim 18 wherein one or more tie bars have a groove configuration.

25. The method of making the tire as set forth in claim 18 wherein one or more tie bars have a solid body configuration.
